(19) United States
(12) Patent Application Publication
(10) Pub. No.: US 2003/0158909 A1
(43) Pub. Date: Aug. 21, 2003

(54) Composite image generation

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/080,788

(22) Filed: Feb. 20, 2002

(51) Int. Cl. G09G 5/00; G06F 15/16

(52) U.S. Cl. 709/217; 345/733

(57) ABSTRACT

A computing system that includes a client computer and a group of server computers is described. The group of server computers includes a server computer that can provide a program of instruction to the client computer. The program of instruction enables the client computer to select images and to create a composite image from the selected images.

### BACKGROUND

In our digital world that we live in today, a user may have access to many different sources of images. These images might be in an electronic or in a paper form.

For example, digital cameras, digital scanners, and personal computers are all typically capable of generating images in an electronic form. Printers, of course, are capable of generating images in a printed form.

A user may wish to combine various images accessed from these different sources into a single composite document. For example, a user may wish to create a composite document that includes an electronic document generated from an application running on his/her personal computer (image #1), a digital picture created by use of a digital camera (image #2) and a printed document (image #3).

Performing this task, however, can present the user with a significant problem. One solution to this problem is to print out the electronic images. Once all of the electronic images are printed, the user can then physically combine and arrange all the printed copies as desired in order to create a single composite document. The user can then, for example, make copies of this newly created document by running it through a copier.

This solution, however, has a number of drawbacks. First, printing the electronic images may result in a loss of image fidelity. Further copying of the printed composite document may lead to additional degradation of image fidelity.

Secondly, the composite document is in a printed form rather than an electronic form. If the document were in an electronic form, the user could fax or e-mail it to others directly from his/her computer. The user could solve this second problem, of course, by converting the printed composite document into an electronic form by using a digital scanner. This can result, however, in a further loss of image fidelity (as well as a significant increase in data size).

Accordingly, what is needed is improved ways to create a composite of multiple images that are obtained from multiple sources.

### SUMMARY

According to one embodiment, for example, the invention provides a method. The method may include, for example, the steps of providing a web client computer connected to a network and providing the web client computer access to a plurality of electronic images. The method may further include receiving, at the web client computer, web content from a remote web server connected to the network. The web content enables the web client computer, in response to user input, to select images from the plurality of images and to create a composite image from the selected images.

### BRIEF DESCRIPTION OF THE DRAWINGS

FIG. 1 is a block diagram of a computing system;

FIG. 2 illustrates how a registered user of a personal computer (PC) can make use of a Word processing application;

FIG. 3 is a block diagram showing the PC connected to a scanner over a network;

FIG. 4A and FIG. 4B are flow diagrams illustrating how a registered user of the PC can make use of the scanner and the PC;

FIG. 5 shows an example of a graphical user interface provided by the scanner;

FIG. 6 is a block diagram showing the PC connected to a server computer over the network;

FIGS. 7A, 7B and 7C are flow diagrams illustrating, by way of example, how a user of the PC can create a composite image;

FIG. 8A illustrates an example of a GUI that enables a user to select images for inclusion in the composite image;

FIG. 8B and FIG. 8C illustrates an example of a GUI that enables a user to define a composite image by arranging the selected images;

FIG. 9 is a block diagram showing the PC connected to a printer over the network;

FIG. 10A and FIG. 10B are flow diagrams illustrating how a user can use web content provided by the printer to print his/her composite image; and

FIG. 11 provides an example of a GUI that may be displayed by the Web content provided by the printer.

### DESCRIPTION

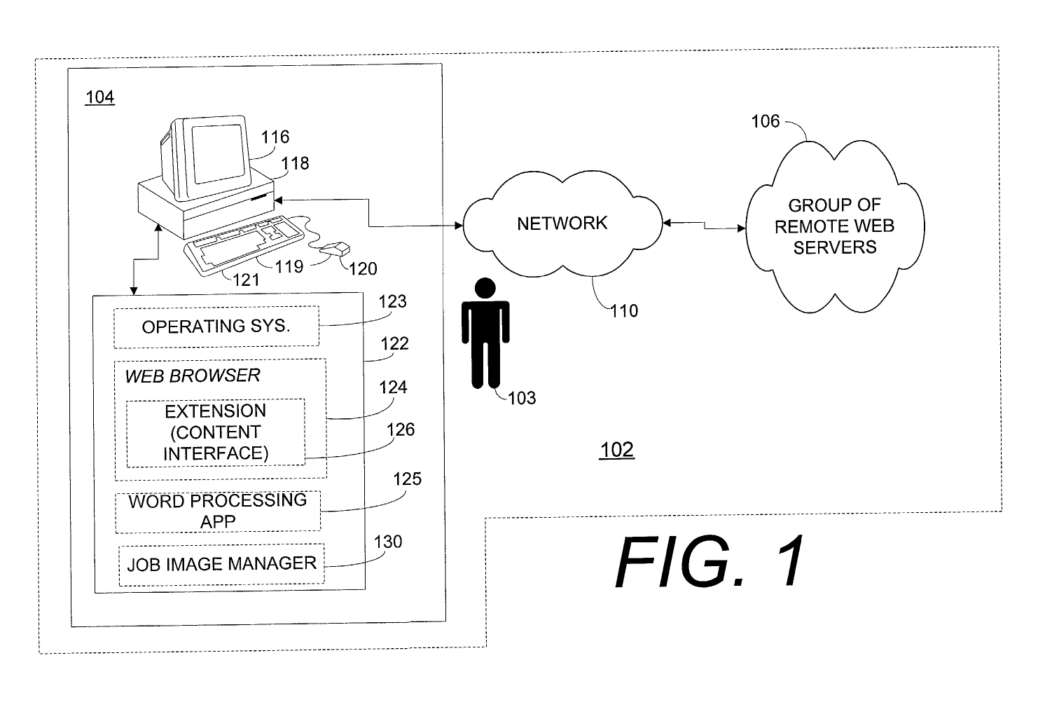

Shown in FIG. 1 is one example embodiment of the invention in the form of a computing system 102. The computing system 102 includes a personal computer (PC) 104 and a group of remote Web server computers 106 all connected to a network 110.

The network 110 can be, for example, an Intranet, a local area network (LAN), a series of networks, a Wide area network (WAN), the Public Internet, etc., or any combination thereof.

The PC 104 includes a display monitor 116, a processing unit 118, user input devices 119 and a memory 122. The user input devices 119, in this embodiment, includes a mouse 120 and a keyboard 121. The memory 122 is depicted being external to the processing unit 118 but may in fact be physically located internally to the processing unit 118.

Stored in the memory 122 is a local operating system (OS) 123, a Web Browser 124, a Word processing application 125 and a “job image manager” 130. The PC 104 automatically runs the OS 123. In order for a new user to access the PC 104, the user first registers an account with the local OS 123. This involves creating a local user account for the new user. The local user's account includes a user name and a unique password that is assigned to the new user.

Once a local user account is established for the new user, the user can then access the PC 104 by logging on. Logging on to the PC 104 involves the user inputting his/her assigned user name and password. This serves to establish the user's online identity. For ease of discussion, a user presently logged into the PC 104 may be referred to herein as the “active user”. In the following discussion, it will be assumed that a user 103 is a registered user of the PC 104. That is to say, the user 103 has a local user account and can therefore log on to the PC 104.

The Web Browser 124 enables the PC 104 to run “Web content” and to function as a Web client computer in the system 102. As used herein, the phrase “Web content” refers to a program of computer readable instructions that may be executed by a Web Browser. Thus, for example, Web content may be a set of instructions written in any of the following languages (the following is a non-exhaustive list): HTML, Java, JavaScript, C-Sharp code, etc, or any combination thereof.

The Web Browser 124 further includes an extension 126. The purpose of the extension 126 is explained in greater detail below.

PERSONAL JOB IMAGE IMAGES

It is noted for the later discussion that, in the present embodiment, there exists a special classification of electronic images. An image that falls into this classification may be referred to herein as a “job image”. Each user of the PC 104, for example, can have their own personal collection of job images. It is noted that a user's “job image” may be a single graphic (e.g., a digital photograph), a multi-page electronic document, etc. It is also noted that a job image may be stored locally or remotely.

In the present embodiment, the job image manager 130 operates to maintain data that identifies each user's personal collection of job images. Thus, for example, when the user 103 is the active user, the job image manager 130 is capable of identifying the user 103's collection of personal job images. It is noted that in some embodiments, the job image manager 130 may be located remotely.

Applications (such as the word processing application 127) that run on the PC 104 may allow an active user of the PC 104 to:

(a) add a new image to the user's collection of job images;

(b) edit one or more of the user's existing job images; and/or

(c) delete one or more of the user's job images.

Additionally, Web content running in the browser 124 can provide the user with this same capability. In part, this capability is achieved by use of the extension 126. As will be discussed in greater detail below, the extension 126 provides a standard application programmatic interface (API) for Web content. Web content running in the browser 124 can access the active user's job images by issuing standard (device independent) calls to the extension 126. That is to say, Web content running in the browser 124 can issue one or more standard calls to the extension 126 in order, for example, to:

(a) add a new image to the active user's collection of job images;

(b) retrieve one or more of the active user's job images; and/or

(c) delete or overwrite one or more of the active user's job images.

CREATION OF PERSONAL JOB IMAGE USING A LOCAL APPLICATION

As indicated above, local applications that run on the PC 104 can be configured to access the active user's collection of job images. The word processing application 125 is an example of such an application.

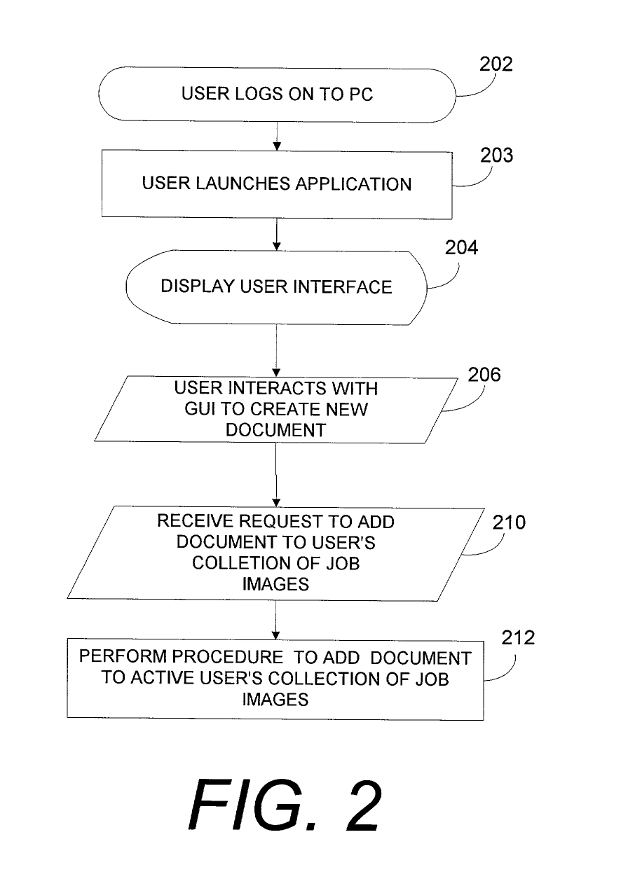

FIG. 2 illustrates, by way of example, how a registered user of the PC 104 can make use of the word processing application 125 in order to create a new job image.

Referring now to FIG. 2, the registered user establishes his/her online identity by logging into the PC 104 (step 202). Next, the user (who is now the active user) launches the Word processing application 125 (step 203). The Word processing application 125, upon being launched, displays an initial graphical user interface (Word processing GUI) (step 204). The Word processing GUI may include a set of menus that allow a user to open an existing document or create a new document. In addition, the Word processing GUI also allows the active user to request that the document presently open in the application 125 be added to his/her personal collection of job images.

At step 206, the active user interacts with the Word processing GUI in order to create a new electronic document. The active user then inputs a request that the new document be added to his/her personal collection of job images.(step 210).

In response to the user input received at step 210, the Word processing application 125 follows a pre-determined procedure that results in the document being classified as being one of the active user's job documents (step 212). It is noted that the Web imaging standard mentioned above may govern certain aspects of the procedure followed in step 212. The standard, for example, may specify that all job images be filed in a portable document file (PDF) format. Thus, step 212 may involve converting the new document into a pre-determined file format, such as PDF.

Step 212 may also include passing the new document to the job image manager 130. The job image manager 130 receives the new document and handles storing it.

It is noted that the job image manager 130 may provide the active user with the option to store his/her job images remotely or locally or some combination thereof. Additionally, in some implementations, an application driver (rather than the application itself) may actually perform portions of or all of the procedure followed at step 212. For example, a printer driver, port monitor, or other related software might be used to perform the step 212 procedure.

CREATION OF PERSONAL JOB IMAGE USING A WEB RESOURCE

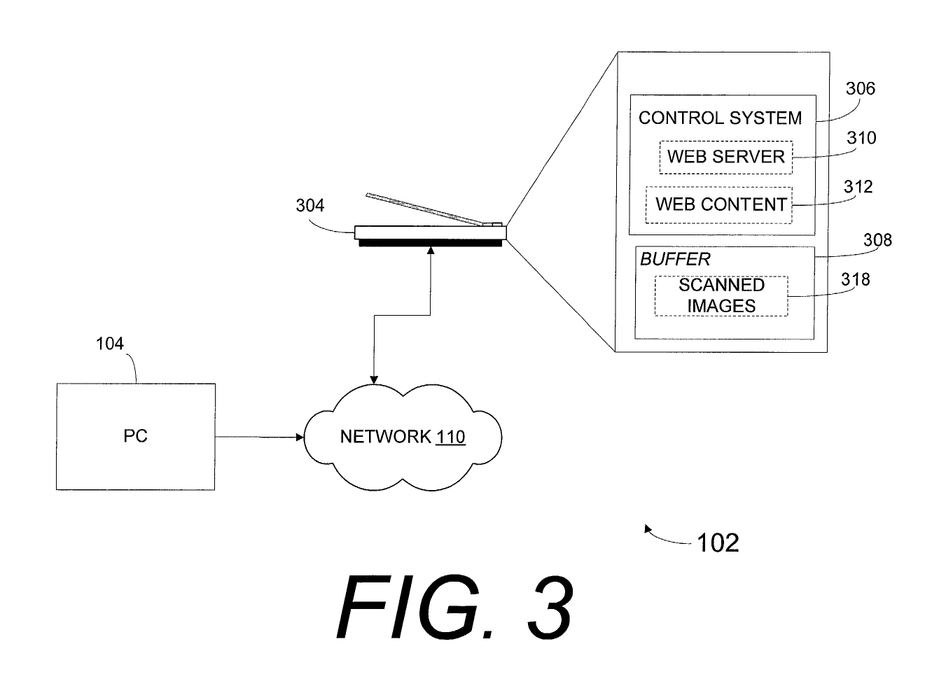

Another way for a registered user of the PC 104 to create a new personal job image is to make use of certain Web resources that are available over the network 110. To illustrate one example of this, attention is directed to FIG. 3.

FIG. 3 is a block diagram showing the PC 104 connected to a scanner 304 over the network 110. The scanner 304 is a member of the group of remote Web servers 106.

As shown, the scanner 304 includes an internal control system 306 and a buffer memory 308. The control system 306 includes an embedded Web server 310. The Web server 310 can serve Web content 312, over the network 110. The Web content 312 is assigned a URL. In some implementations, the Web content 312 may be generated dynamically. A Web client (such as the PC 104) can retrieve the Web content 312 by transmitting an appropriate request (addressed to the URL assigned to the Web content 312) to the Web server 310 over the network 110. The Web server 310 responds to the request by transmitting the Web content 312 to the requesting Web client.

The scanner 304 may be used to convert a hard copy document into a digital image. The scanner 304 can be configured so that when the document is scanned, the digital image that is generated is stored in the buffer memory 308.

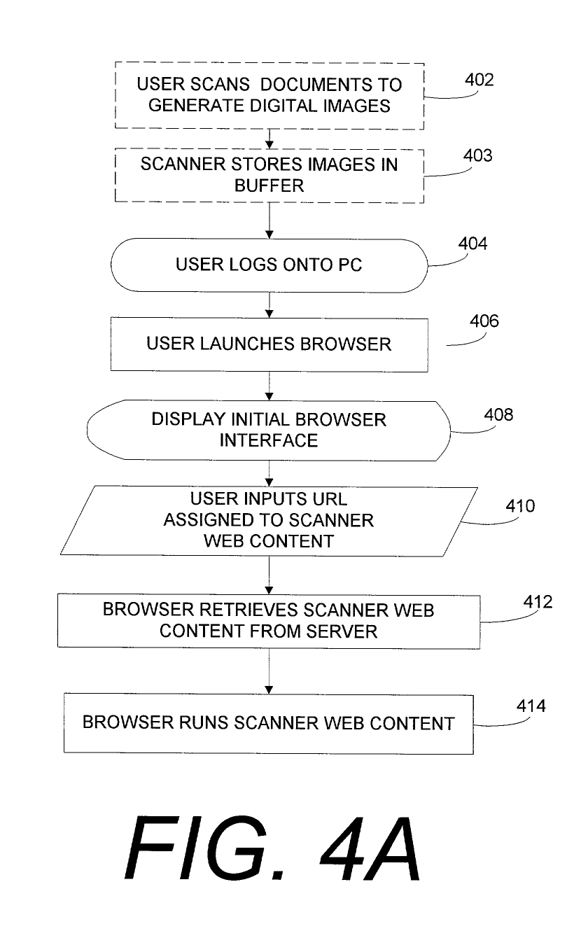

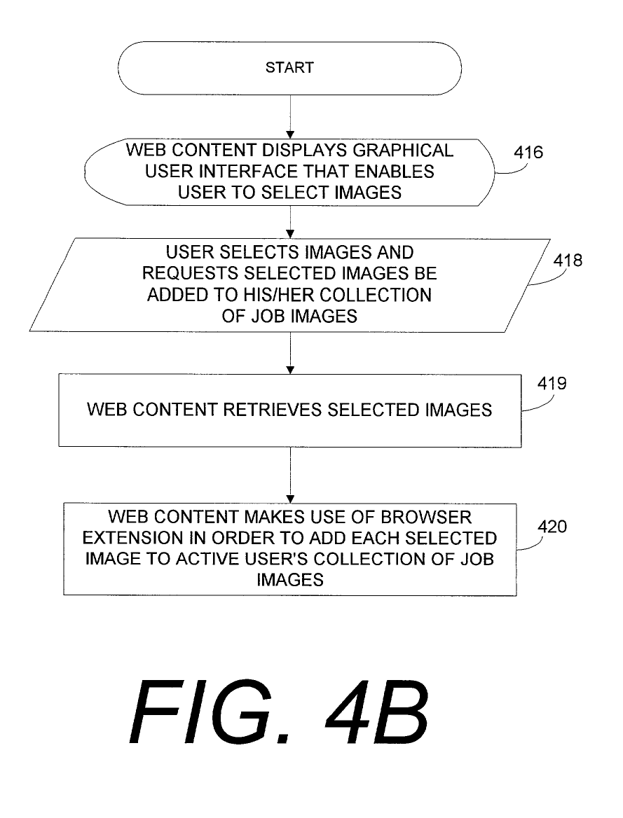

FIG. 4A and FIG. 4B are flow diagrams illustrating, by way of example, how a registered user of the PC 104 can make use of the scanner 304 and the PC 104 in order to create a new personal job image.

Turning now to FIG. 4A, the user interacts with the scanner 304 in order to scan several documents (step 402). For each document scanned, the scanner 304 creates a corresponding digital image of the document and then places the digital image in the buffer memory 308 (step 403).

In the next part of this discussion, it will be assumed that the user has created a set of scanned images 318 by following this process. The scanned images 318 are shown stored in the buffer memory 308.

After creating the scanned images 318, the user then logs on to the PC 104 and launches the Web Browser 124 (step 404 and step 406). The Browser 124, upon being launched, displays an initial graphical user interface (browser GUI) (step 408).

The user (who is now the active user) interacts with the browser GUI in order to request the Web content 312 (step 410). This step can involve the user inputting the URL assigned to the Web content 312.

In response to this user input, the browser 124 responds by retrieving the Web content 312 over the network 110 from the scanner Web server 310 (step 412). At step 414, the Web Browser 124 runs the Web content 312.

FIG. 4B illustrates the operation of the Web content 312 while running in the Browser 124 at step 414. Turning now to FIG. 4B, the Web content 312 displays a graphical user interface (scanner GUI) (step 416). The scanner GUI allows the active user (i.e., the user presently logged on the PC 104) to:

(a) select one or more of the images that that are stored in the scanner buffer 308; and

(b) add the selected images to his/her collection of job images.

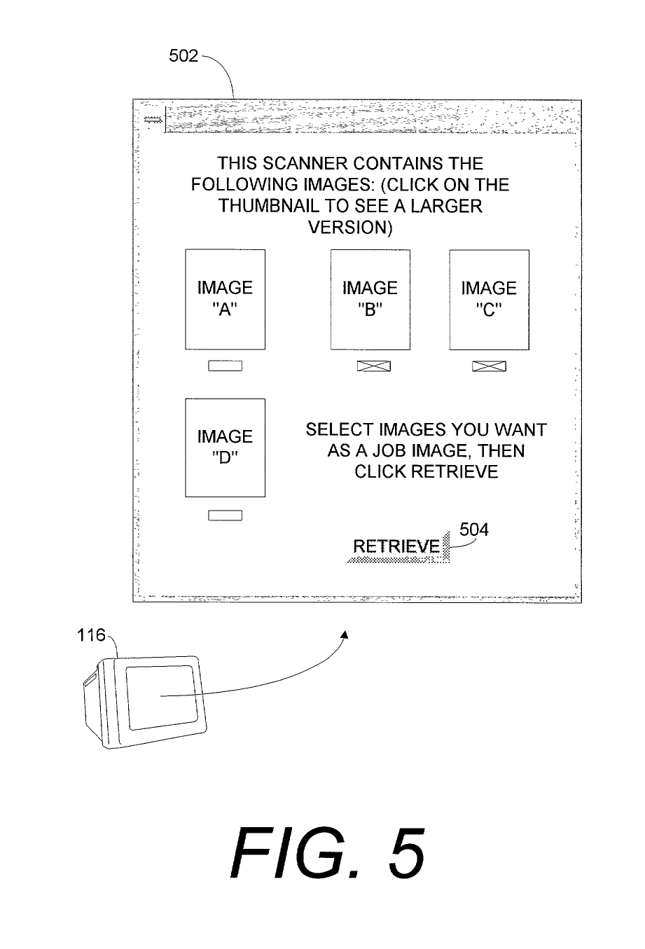

FIG. 5 shows an example of a scanner GUI that may be displayed by the Web content 312 at step 416. In this example, the scanner GUI is a Web page 502 that provides a set of images (images A-D). These images are thumbnail versions of the scanned images 318 presently stored in the buffer memory 308.

The user can select one or more of these images (image “B” and image “C” are shown selected). The user can then select a “retrieve button” 504. Selecting the “retrieve button” 504 causes the Web content 312 to retrieve and add these images to the active user's collection of job images.

Referring again to FIG. 4B, the user is assumed to interact with the scanner GUI in order to

(a) select one or more of the scanned images 318; and

(b) request that the selected images be added to the user's collection of job images.

The Web content 312 receives this user input at step 418. In response to this user input, the Web content 312 retrieves the selected images (over the network 110) from the buffer memory 308 (step 419). The Web content 312 further responds by following a pre-determined procedure in order to add the retrieved images to the active user's collection of job images (step 420).

The procedure followed by the Web content 312 at step 420 may involve converting the selected images into a format determined by the Web imaging standard. As mentioned above, the standard may specify that job images be in a PDF format. Thus, the Web content 312 may operate to convert the selected images into a PDF format.

The procedure may also include the Web content 312 issuing one or more standard API calls to the extension 126. The extension 126 responds to these calls by enabling the Web content to add the selected images to active user's collection of job images. Thus, for example, if the user 103 is presently logged into the PC 104 when step 420 is performed, the extension 126 enables the Web content 312 to add the selected images to the user 103's collection of job images. It is noted that the extension 126 may operate to pass the select images to the job image manager 130. The job image manager 130, in turn, may operate to store the image appropriately. Additionally, the job manager 130 updates itself so that it can later identify the stored document as being a member of one of the active user's job images.

CREATION OF A COMPOSITE IMAGE

From the foregoing, it can be seen the computing system 102 may offer a registered user of the PC 104 many different ways to create job images. Only two examples were provided, but it can be seen that many types of local applications (running locally on the PC 104) or Web content (provided over the network 110) could enable a user to create a job image. In fact, in view of the fact that the network 110 may represent the public Internet, the user may have access to a vast number of different Web resources that allow the user to create new job images.

In the next part of this discussion, it is shown how Web content can enable a user of the PC 104 to create a composite image from his/her job images. The Web content may further allow a user to print the composite image.

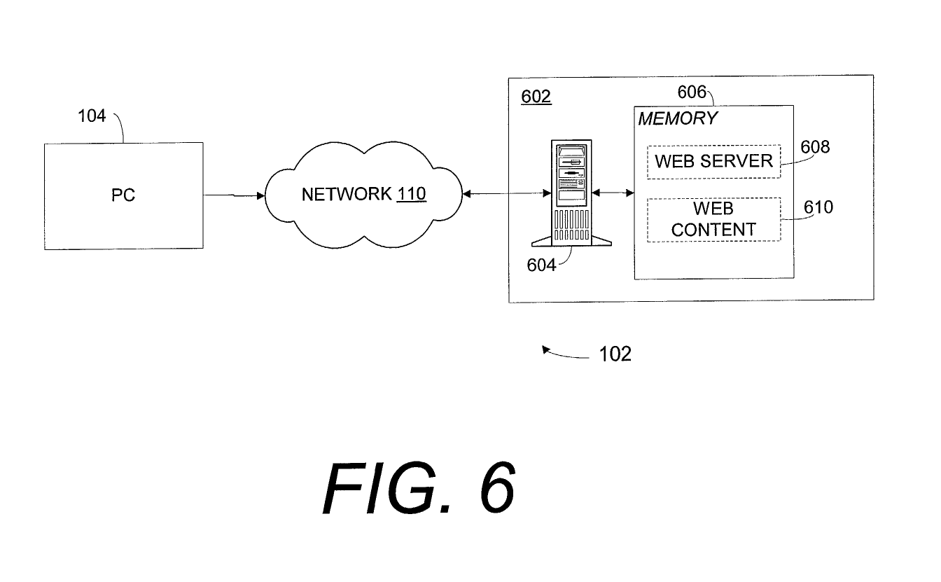

FIG. 6 is a block diagram showing the PC 104 connected to a web server computer 602 over the network 110. The web server computer 602 is a member of the group of remote Web servers 106.

As shown, the server computer 602 includes a processing unit 604 and a memory 606. Stored in the memory 606 is a Web server program 608 and Web content 610. The processing unit 604 runs the Web server program 608.

The Web Server 608 can serve the Web content 610 over the network 110. It is noted that in some embodiments, the Web content 610 may be generated dynamically through the use of programming logic running on the server. This programming logic may dynamically generate the actual web page (and possibly images, etc., associated with the web page).

The Web content 610 is assigned a unique URL. A Web client (such as the PC 104) can retrieve the Web content 610 by transmitting an appropriate request (addressed to the URL assigned to the Web content 610) to the Web server 610 over the network 110. The Web server 608 responds to the request by transmitting the Web content 610 to the Web client computer.

In general, the Web content 610 enables the PC 104, in response to user input, to create a composite image from images selected from the active user's collection of job images.

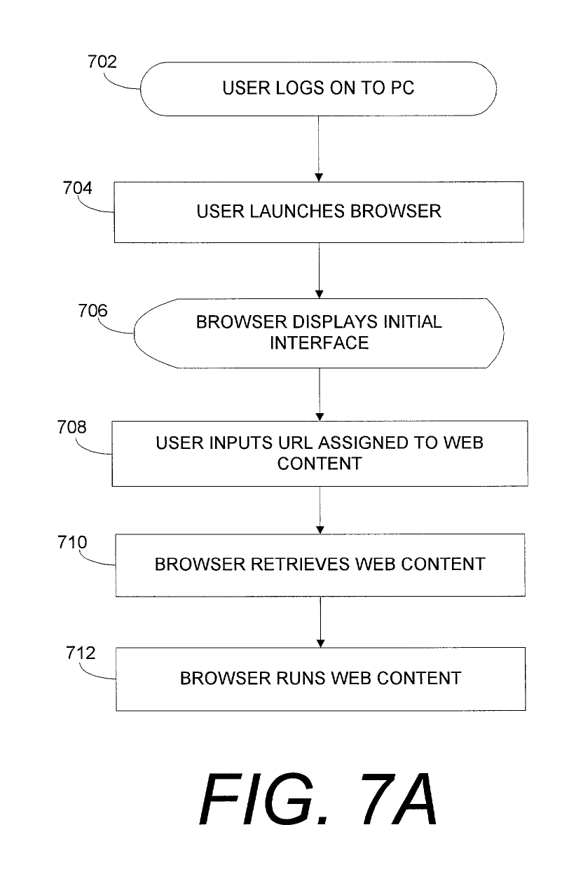

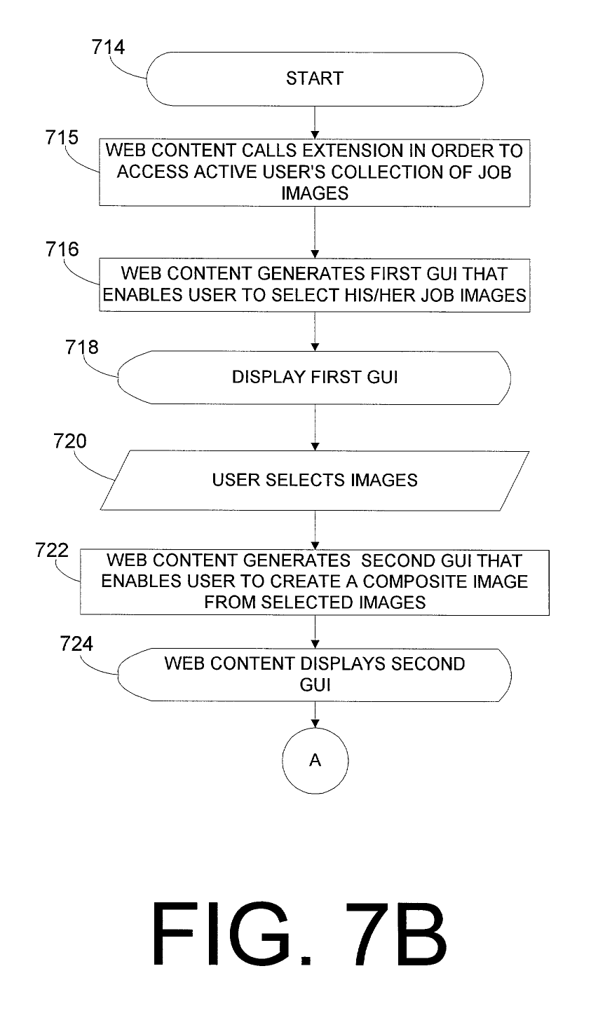

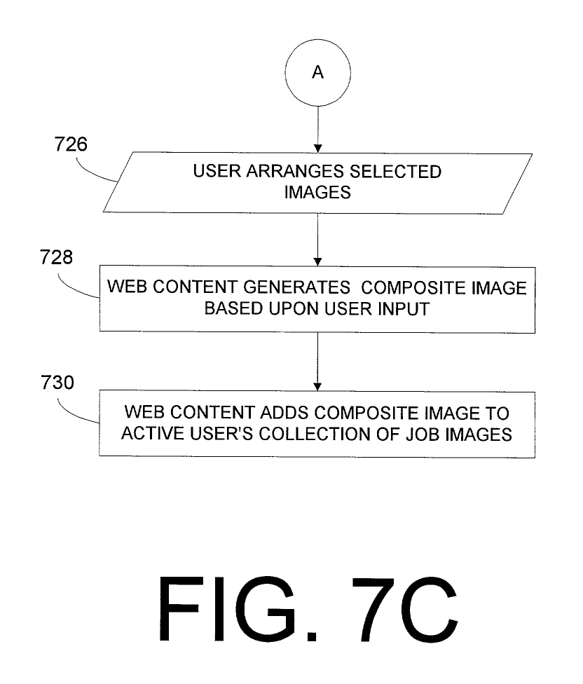

FIGS. 7A-C are flow diagrams illustrating, by way of example, how a registered user of the PC 104 (e.g., the user 103) can make use of the Web content 610 to create a composite image. Turning first to FIG. 7A, a registered user logs on to the PC 104 and launches the Web Brower 124 (step 702 and step 704).

The Browser 124, upon being launched, displays an initial graphical user interface (browser GUI) (step 706). The user interacts with the browser GUI in order to request the Web content 610 (step 708). This step may involve the user inputting the URL assigned to the Web content 610.

In response to this user input, the browser 124 retrieves the Web content 610 over the network 110 from the Web server 608 (step 710). At step 712, the Browser 124 runs the Web content 610.

FIG. 7B illustrates the operation of the Web content 610 while running in the Browser 124 at step 712. Turning now to FIG. 7B, the Web content 610 issues one or more standard calls to the extension 126 in order to access the active user's collection of job images (step 715). Thus, for example, if the user 103 had logged on to the PC 104 at step 702, the Web content 610 would access the user 103's personal job images at step 715. The extension 126, in response to the call, may make use of the job image manager 130 in order to locate the user 103's personal job images. The job image manager 130 may actually retrieve the user's 103's personal job images and pass these images to the extension 126. The extension 126, in turn, may pass the images to the Web content 610.

The Web content 610 makes use of the imaging information obtained at step 715 in order to generate a first graphical user interface (first GUI) (step 716). The first GUI includes a list of the active user's job images. Furthermore, the first GUI allows the user to select those images from the list that the user wishes to be included in a composite image.

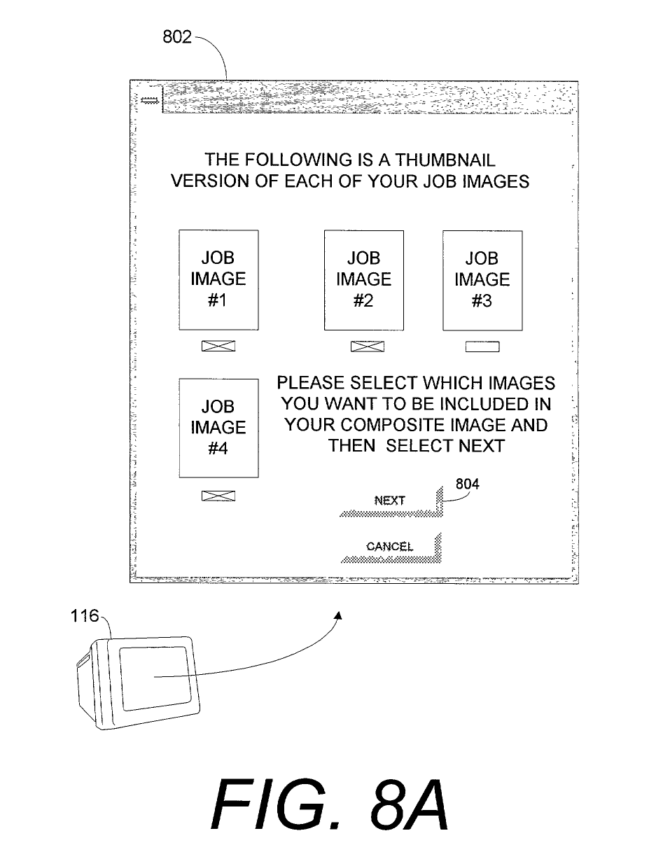

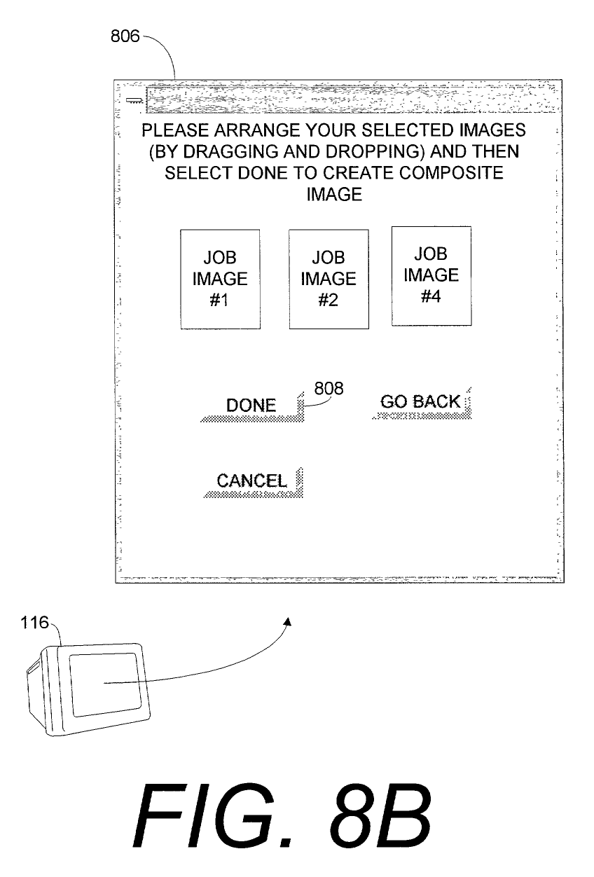

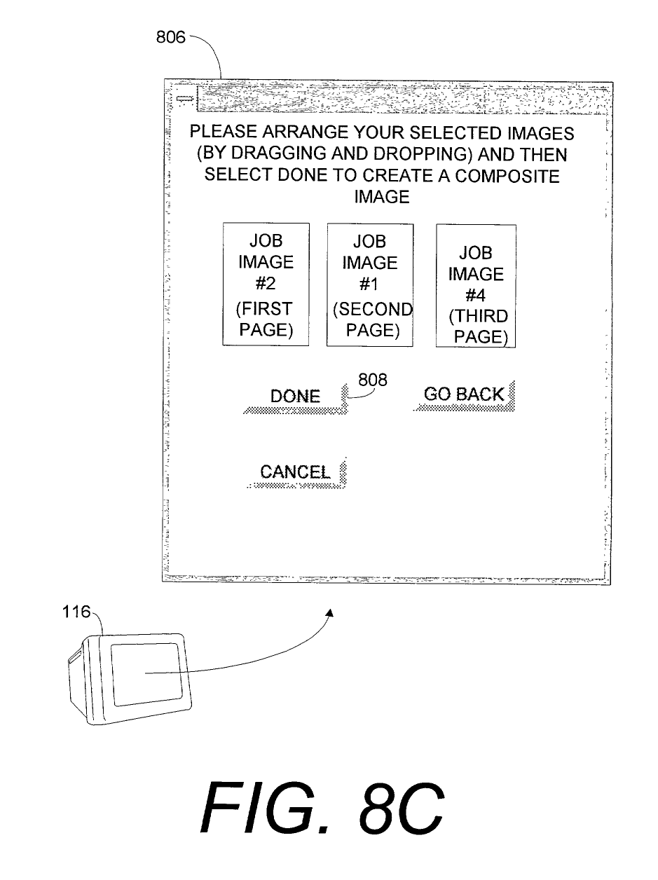

FIG. 8A illustrates an example of a first GUI that may be displayed at step 716. Turning briefly to FIG. 8A, the GUI is, in this example, a Web page 802.

As shown, the Web page 802 provides a thumbnail version of each of the active user's job images. The imaging information to generate each thumbnail image can be obtained by the Web content 610 at step 715.

In this example, the active user has four personal job images: job image #1, job image #2, job image #3 and job image #4. Job image #1 could be, for example, an electronic document created locally on the PC 104 by use of the word processing application 125. Job image #2 and job image #3 could be, for example, images retrieved over the network 110 from the scanner buffer 308. Job image #4 could be an image retrieved from some other source (not shown), such as a digital camera. As indicated above, some of these job images may actually include one or more pages comprising multiple graphics. Other job images may be a single graphic.

The user can interact with the Web page 802 in order to indicate which of his/her personal job images he/she wishes to be included in a composite image. In this example, the user has selected “job image #1, job image #2 and job image #4.

After the user has selected the desired job images, the user can then select the “next” button 804 in order to move on to the next user interface (see FIG. 8B). As will be seen, the next user interface (second GUI) allows the user to assemble the selected job images into a single composite image.

Referring again to FIG. 7B, the user interacts with the first GUI in order to select his/her personal job images that he/she wishes to be included in the composite image. The Web content 610 receives this user input at step 720.

In response to the user input received at step 720, the Web content 610 operates to generate a second GUI (step 722). The second GUI allows the user to define a composite image that includes the selected job images. The Web content 610 proceeds to display the second GUI (step 724).

FIG. 8B illustrates an example of a second GUI that may be displayed at step 724. In this example, the second GUI is a Web page 806.

Turning briefly to FIG. 8B, the Web Page 806 provides a thumbnail version of each job image that was selected at step 720. The user can interact with the Web Page 806 in order to define a composite image of the selected images. In this example, the user can define the composite image by dragging and dropping the images in the order he/she desires. After assembling the images in this manner, the user can then select a “done button” 808.

FIG. 8C shows an updated Web page 806 after the user has arranged the images. In this case, the user has indicated that he/she wishes job image #2 to be the first page in the composite image, job image #1 to be the second page and the job image #4 to be the third page.

Referring now to FIG. 7C, the user is assumed to interact with second GUI in order to define an arrangement of the selected images. The Web content 610 receives this user input at step 726.

In response to this user input, the Web content 610 generates a composite image that includes the active user's job images selected at step 720. The job images are arranged as per the user input received at step 726.

The Web content 610 then proceeds to add the composite image to the active user's collection of job images (step 730). Thus, in this manner, a new personal job image (i.e., the composite image) is created for the active user. Step 730 may be accomplished by the Web content 610 issuing an appropriate standard call to the extension 126. The extension 126 may respond to the call by passing the composite image to the job image manger 130. The job image manager 130 then stores the composite image appropriately. Additionally, the job manager 130 updates it's own data so that it can later identify the stored document as being a member of one of the active user's job images.

It is noted that the creation of the composite image can be accomplished without necessarily making a duplicate copy of each job image that makes up the composite. Each of these “constituent job images” can remain unchanged and simply be referred to by the composite image. Alternatively, in situations where there is concern that the constituent job images might be modified, copies of the constituent job images can be used. In some instances, an option may be provided for choosing whether the constituent job image is duplicated or instead added to the composite image by reference.

It is also noted that in other embodiments, the GUI displayed at step 718 or step 724 may provide the user with additional options to create a composite image. For example, these interfaces may allow a user to select individual pages from multi-page job images and arrange these pages as desired into a composite image. For example, a composite image may be created that comprise three pages:

(a) page 1 of the composite image may be page 3 from job image #2;

(b) page 2 of the composite image may be page 1 from job image #1; and

(c) page 3 of the composite image may be page 1 from job image #4.

Furthermore, the user may also be given the option to create a composite image that includes more than one job image positioned onto a single page. This may be accomplished by using cropping, as well as “cut and paste” manipulation techniques. Additionally, the user may be given the option to control the X-Y position of each job image on a single page.

Thus, for example, it is envisioned that a user may be given the option to create a composite image that includes a first and a second page. The first page of the composite image may include, for example, page 3 of job image #2 and page 4 from job image #1. The user may determine the position and size of these two pages (i.e., page 3 of job image #2 and page 4 of job image #1) on the single composite image page.

In this embodiment, the composite image after having been created is handled the same as any other job image. Additional composite images may be created, therefore, that combine the just created composite image with other job images.

PRINTING THE COMPOSITE IMAGE

Once the composite image has been added to the user's collection of job images, the user can then make use of local applications or Web content to further process the image.

One important type of processing function is printing. Local applications, as well as Web content, may be configured to provide this function. The following discussion illustrates an example of how Web content may enable the PC 104 to print the composite image.

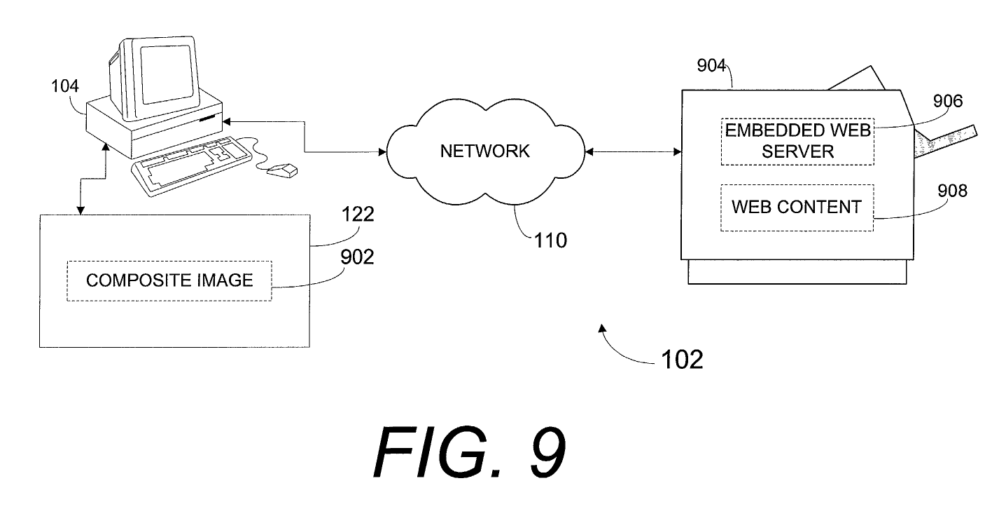

FIG. 9 is a block diagram showing the PC 104 connected to a printer 904 over the network 110. Stored in the PC memory 122 is a composite image 902. It will be assumed in the following discussion that the user 103 created the composite image 902 by interacting with the Web content 610 as described above. The composite image 902 is, therefore, one of the user 103's personal job images. It is also noted that the composite image 902 is shown stored locally. As indicated above, it is contemplated that a user's job images may also be stored remotely.

As shown, the printer 904 includes an embedded Web server 906 that is capable of serving Web content (printer Web content) 908. The printer Web content 908 is assigned a unique URL. The printer Web server 906 is capable of serving the printer Web content 908 to Web clients over the network 110 upon receiving a request addressed to the URL.

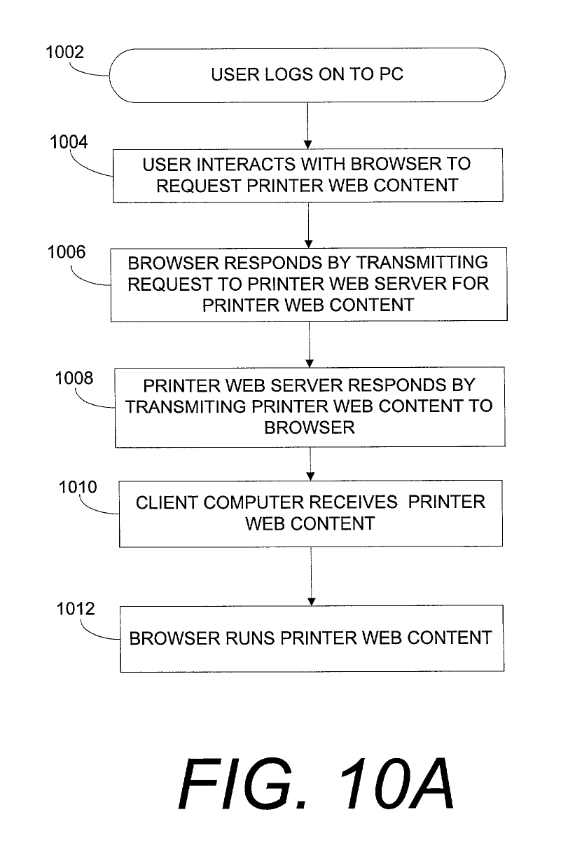

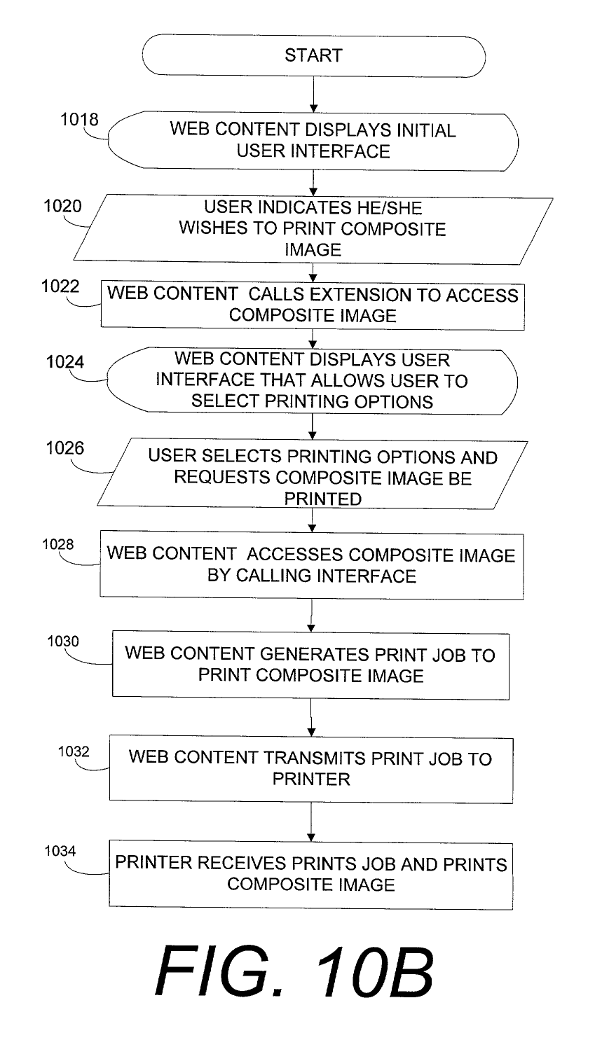

FIG. 10A and FIG. 10B are flow diagrams illustrating, by way of example, how the user 103 can use to the printer Web content 908 to print the composite image 902.

Turning now to FIG. 10A, the user 103 establishes his/her online identity by logging on to the PC 104 (step 1002). The user 103 then interacts with browser 124 in order to request the printer Web content 908 (step 1004). This step may involve the user 103 inputting the URL assigned to the printer Web content 908.

In response to the user input received at step 1004, the Browser 124 operates to transmit an appropriate request to the printer Web Server 906 (step 1006). The printer Web server 908 receives the request and responds by transmitting the printer Web content 908 to the personal computer 104 (step 1008). The PC 104 receives the printer Web content 908 (step 1010) and the browser 124 runs it (step 1012).

FIG. 10B is a flow diagram illustrating the operation of the printer Web content 908 at step 1012. Referring now to FIG. 10B, the Web content 908 displays a user interface that allows the user to designate which of the user's job images he/she wishes to print (step 1018). The Web content 908 may indicate a default selection, such as the last image added the active user's collection of job images.

It is noted that one or more of an active user's job images may be further classified as being an “active” job image. These job images may be used as the default selections. It also noted that in order to provide the user with the choice of which job image is to be printed (as described in step 1018), it may be necessary to access the active user's collection of the job images. Thus, step 1018 may include issuing one or more standard calls to the extension 126.

The user 103 interacts with the user interface displayed at step 1018 in order to request that the composite image 902 be printed (step 1020). In response to this user input, the printer Web content 908 operates to call the extension 126 in order to access the composite image 902 (step 1022). Next, the printer Web content 908 operates to display a graphical user interface (printer GUI) that allows the user 103 to select various printing options that are offered by the printer 904 (step 1024). The printer GUI may also include a print-preview image of the composite image 902. The print-preview image can be based upon the imaging information received at step 1022.

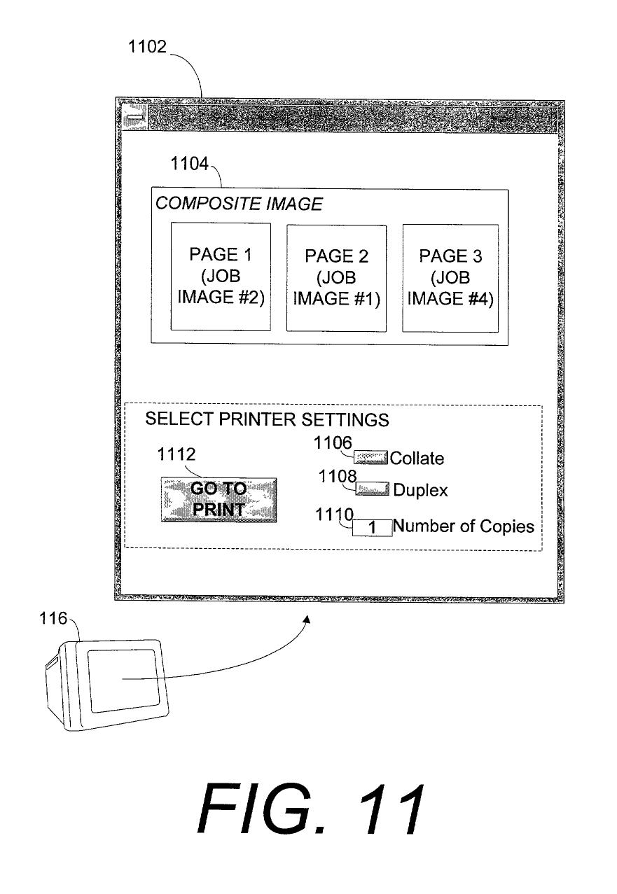

For illustration purposes, FIG. 11 provides an example of a GUI 1102 that may be displayed by the printer Web content 908 at step 1024. As shown, the printer GUI 1102 allows the user to select certain printer options. For example, the printer GUI 1102 allows the user to select a document collation option 1106 and a duplex printing option 1108. In addition, the user can enter the number of copies he/she wishes to print by inputting the desired number in an input field 1110.

The GUI 1102 also includes a print preview image 1104. The print preview image 1104 provides a visual representation of how the composite image 902 will be printed using the printer 904. The print preview image 1104 can be based upon the imaging information received at step 1022 as well as the capabilities of the printer 904. As shown, in this example, the composite image 902 includes an arrangement of three of the user 103's job images.

After the user has selected his/her desired print settings, the user can then select the “go to print button” 1112 to request that the composite image 902 be printed.

Referring again to FIG. 10B, the user interacts with the printer GUI displayed at step 1024 in order to:

a) select his/her desired print settings; and

b) request the composite image 902 be printed.

The printer Web content 908 receives this user input at step 1026.

In response to this user input, the Web content 908 accesses the composite image 902 again by issuing a standard call to the extension 126 (step 1028). The printer Web content 908 then uses the imaging information received at step 1028 to create a print job (step 1030). The print job is suitable to print the composite image 902 according to the print settings received at step 1026

At step 1032, the printer Web content 908 causes the print job to be transmitted to the printer 904 via the network 110. The printer 904 receives the print job and prints it, thereby generating a printed version of the composite job image 902.

It can be seen that the computing system 102 can offer a user, such as a user of the PC 104, a great many image sources. These image sources can be based locally on a client computer (e.g., the application 125) or provided by a Web Server Computer (e.g. the scanner 304). Furthermore, the computing system 102 provides a user with an advantageous way to generate a composite image, electronically, from these various sources. The composite image is in an electronic form and can therefore be electronically processed (e.g., printed, e-mailed, faxed, etc) using local or Web based resources.

In the foregoing discussion, it can be seen that the extension 126 provides a client side mechanism that can provide a web resource access to the user's job images when the user is actively using the resource. The user's job images are identified based upon his/her online identity that exists on the client side.

It should be understood, however, that other mechanisms (including server side or system wide mechanisms) might be used to provide this same or similar functionality. For example, a user's collection of job images may be linked to his/her online identity that exists on a server or to an online identity that exists across a network system.

In some embodiments, for example, a remote server (document server) is provided that allows a user to establish a server side online identity, which may be defined by a user identifier (document server ID). The user can then remotely interact with the document server in order to designate a document to be his/her personal job image.

In these embodiments, a Web server that provides a Web resource can be configured to contact the document server in order to access the user's job image when the user is actively making use of the web resource. In order to enable this access, the user provides his/her document server ID to the Web server. The Web server can then make use of this information to interact with the document server in order to access the user's personal job images. This can be accomplished directly (as indicated) or indirectly. For example, the Web server might actually get the identity of the user and this identity may be used to obtain the document server ID. Even the identity of the user may be obtained indirectly, using for example techniques such as those employed by MICROSOFT PASSPORT where the user's identity is obtained by MICROSOFT PASSPORT and relayed back to the Web server.

In this manner, therefore, the Web server is able to access the client user's selected job image and use that document to synthesize Web content (that allows a user to define a composite image and add the composite image to the user's collection of job images). The Web content is then transmitted to the client.

It is important to also note that the present invention may be embodied in the form of a “computer readable medium”. For example, a memory that stores (either temporarily or permanently) the Web content described above may be considered an embodiment of the invention. It is also noted that the phrase “computer readable medium” can refer to any medium that can contain, store or propagate computer readable instructions. Thus, in this context, the phrase “computer readable medium” may refer to a medium such as a CD ROM or to signals that are used to communicate the computer readable code over a network, such as the Public Internet. The phrase “computer readable medium” may also refer to a carrier wave.

Although several specific embodiments of the invention have been described and illustrated, the invention is not to be limited to specific forms or arrangements of parts so described and illustrated. For example, a remote server that is not embedded in the printer may provide the printer Web server described above. Also, the Personal computer may alternatively represent a personal digital assistant (PDA). The invention is limited only by the claims and the equivalents thereof.

What is claimed is:

1. A method, comprising:
(a) providing a web client computer connected to a network;
(b) providing the web client computer access to a plurality of electronic images;
(c) receiving, at the web client computer, web content from a remote web server connected to the network; and
wherein the web content enables the web client computer, in response to user input, to select images from the plurality of images and to create a composite image from the selected images.

2. The method of claim 1, wherein the web content enables the web client computer to display a first graphical user interface for enabling a user of the client computer to provide the user input.

3. The method of claim 2, further comprising:
(d) receiving the user input at the client computer;
(f) responding to the user input at the client computer by creating the composite image.

4. The method of claim 2, further comprising:
(d) receiving, at the web client computer, second web content from a second remote server connected to the network; and
wherein the second web content enables the web client computer, in response to second user input, to convert the composite image into a print job and to then transmit the print job to a particular printer connected to the network.

5. The method of claim 2, further comprising:
(d) receiving, at the web client computer, second web content from a second remote server connected to the network; and
wherein the second web content enables the web client computer to process the composite image.

6. The method of claim 4, wherein the second web content enables the web client to display a second graphical user interface for enabling the user to provide the second user input.

7. The method of claim 5, further comprising:
(e) receiving the second user input at the web client computer;
(f) responding the second user input at the client computer by converting the composite image into a print job and then transmitting the print job to the printer over the network.

8. The method of claim 7, wherein the first graphical user interface and the second graphical user interface each includes at least one web page.

9. A computing system, comprising:
(a) a web client computer having access to a plurality of electronic images; and
(b) a first web server computer connected to the web client computer over a network; and
wherein the first web server computer with the capability to provide first web content to the web client computer; and
wherein the first web content enables the web client computer to, in response to first user input, create a composite image that includes images selected from the plurality of electronic images.

10. The computing system of claim 9, wherein the first web content enables the web client computer to display a graphical user interface for enabling a user of the web client computer to provide the first user input.

11. The computing system of claim 9, further comprising:
(c) a second web server computer connected to the network; and
wherein the second web server computer having the capability to provide second web content to the web client computer; and
wherein the second web content enables the web client computer, in response to second user input, to convert the composite image into a print job and to transmit the print job to a particular printer.

12. The computer system of claim 9, wherein the first web content enables the web client to display at least one web page that provides a graphical user interface for enabling a user of the web client computer to provide the first user input in order to create the composite image.

13. The computer system of claim 9, wherein the network is the public Internet.

14. The computer system of claim 9, wherein the first web server provides the first web content to the web client computer by transmitting the first web content to the web client computer over the network using an http protocol.

15. A Web server computer, comprising:
(a) an interface for receiving a request from a web client over a network; and
(b) a mechanism for responding to the request by transmitting web content, over the network, to the web client; and
wherein the web client computer has access to a plurality of electronic images;
wherein the web content enables the web client to, in response to first user input, select images from the plurality of electronic images; and
wherein the web content enables the web client computer to, in response to second user input, create a composite image from the selected images.

16. The web server computer of claim 15, wherein the web content causes the web client computer to display a user interface that enables a user of the web client computer to provide the first and the second user input.

17. The Web server computer of claim 15, wherein the request is addressed to a URL assigned to the web content.

18. A computing device, comprising:
(a) means for receiving a request from a web client computer over a network, the request address to a pre-determined URL; and
(b) means for responding to the request by transmitting a program of instructions to the web client computer; and
wherein the program of instructions enables the web client computer to select electronic images and to create a composite image from the selected images.

19. The computing device of claim 18, wherein the program of instructions is web content.

20. The computing device of claim 18, wherein the network is the Public Internet.

21. A computer readable medium embodying Web content for causing a Web client computer to perform method steps, the method steps comprising:
(a) receiving first input from a user that identifies a plurality of electronic images;
(b) receiving second input from the user that defines an arrangement of the electronic images;
(c) creating a composite image based upon the first and second input; and
(d) displaying at least one web page that includes a graphical user interface for enabling the user to provide the first and the second user input.

22. The computer readable medium of claim 21, wherein the at least one web page includes a plurality of thumbnail images each corresponding to a unique one of the plurality of electronic images.

23. The computer readable medium of claim 21, wherein the method steps further comprising:
(e) configuring the Web client computer so that when the client computer is running second Web content and a particular user is logged into the client computer, the second Web content can access the composite image by issuing a pre-determined application program interface (API) call.

24. The computer readable medium of claim 23, wherein the API call is device independent.
